(19) United States
(12) Patent Application Publication
(10) Pub. No.: US 2023/0284224 A1
(43) Pub. Date: Sep. 7, 2023

(54) TERMINAL, RADIO COMMUNICATION METHOD, AND BASE STATION

(71) Applicant: NTT DOCOMO, INC., Tokyo (JP)

(72) Inventors: Yuki Takahashi, Tokyo (JP); Shinya Kumagai, Tokyo (JP); Satoshi Nagata, Tokyo (JP)

(73) Assignee: NTT DOCOMO, INC., Tokyo (JP)

(21) Appl. No.: 18/006,974

(22) PCT Filed: Jul. 31, 2020
(86) PCT No.: PCT/JP2020/029549

§ 371 Date: Jan. 26, 2023

(51) Int. Cl. H04W 72/21; H04W 72/0446; H04W 72/566; H04W 72/54

(52) U.S. Cl. CPC H04W 72/21; H04W 72/0446; H04W 72/566; H04W 72/54

(57) ABSTRACT

A terminal according to an aspect of the present disclosure includes a control section that, when a plurality of UL channels repeatedly transmitted one or more times in a slot and channel state information using an uplink control channel overlap in a time domain, and priorities of the plurality of UL channels and the channel state information are same, performs control to map the channel state information to a specific UL channel out of the plurality of UL channels, and a transmitting section that transmits at least one of the plurality of UL channels and the channel state information.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+(plus),” “New Radio (NR),” “3GPP Rel. 15 (or later versions),” and so on) are also under study.

Existing systems (for example, Rel. 15 or earlier versions) support a configuration in which a UE feeds a transmission confirmation signal (an HARQ-ACK, an ACK/NACK, or an A/N) back to DL data (for example, a PDSCH), such that retransmission of the PDSCH is controlled.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, 5G, NR, and the like), for example, it is assumed that a plurality of traffic types (also referred to as services, types, service types, communication types, use cases, and the like) having different requirements coexist, such as high speed and high capacity (for example, enhanced Mobile Broad Band (eMBB)), ultra massive terminals (for example, massive Machine Type Communication (mMTC), Internet of Things (IoT)), and ultra high reliability and low latency (for example, Ultra Reliable and Low Latency Communications (URLLC)).

In existing systems, aperiodic channel state information (for example, A-CSI) report is controlled using an uplink shared channel (for example, a PUSCH). In contrast, in Rel. 17 or later versions, it is assumed that A-CSI report using an uplink control channel (for example, a PUCCH) is also supported.

However, when the PUCCH (or PUCCH resources) used for transmission of the A-CSI and another UL transmission (for example, repetition transmission of the PUSCH) collide in a time domain, how to control the UL transmission has not been fully studied.

In view of this, the present disclosure has an object to provide a terminal, a radio communication method, and a base station that enable appropriate control of UL transmission even when A-CSI using an uplink control channel is supported.

### Solution to Problem

A terminal according to an aspect of the present disclosure includes a control section that, when a plurality of UL channels repeatedly transmitted one or more times in a slot and channel state information using an uplink control channel overlap in a time domain, and priorities of the plurality of UL channels and the channel state information are same, performs control to map the channel state information to a specific UL channel out of the plurality of UL channels, and a transmitting section that transmits at least one of the plurality of UL channels and the channel state information.

### Advantageous Effects of Invention

According to an aspect of the present disclosure, even when A-CSI using an uplink control channel is supported, UL transmission can be appropriately controlled.

### BRIEF DESCRIPTION OF DRAWINGS

FIG. 1A and FIG. 1B are diagrams to show examples of repetition transmission of PUSCH;

FIG. 2 is a diagram to show another example of repetition transmission of PUSCH;

FIG. 3A to FIG. 3C are diagrams to show examples of timelines for a PUCCH/PUSCH;

FIG. 4 is a diagram to show an example of parameters used for determination of the timeline for the PUCCH;

FIG. 5 is a diagram to show an example of parameters used for determination of the timeline for the PUSCH;

FIG. 6 is a diagram to show an example of a case in which A-CSI using the PUCCH and the PUSCH to which repetition transmission is applied overlap (collide) in a time domain;

FIG. 7A to FIG. 7C are diagrams to show examples of UL transmission control according to a second aspect;

FIG. 8A to FIG. 8C are diagrams to show other examples of UL transmission control according to the second aspect;

FIG. 9A and FIG. 9B are diagrams to show other examples of UL transmission control according to the second aspect;

FIG. 10A and FIG. 10B are diagrams to show other examples of UL transmission control according to a fourth aspect;

FIG. 11 is a diagram to show an example of a schematic structure of a radio communication system according to one embodiment;

FIG. 12 is a diagram to show an example of a structure of a base station according to one embodiment;

FIG. 13 is a diagram to show an example of a structure of a user terminal according to one embodiment; and

FIG. 14 is a diagram to show an example of a hardware structure of the base station and the user terminal according to one embodiment.

### DESCRIPTION OF EMBODIMENTS

### <Services (Traffic Types)>

In future radio communication systems (for example, NR), traffic types (also referred to as types, services, service types, communication types, use cases, or the like), such as further enhancement of mobile broadband (for example, enhanced Mobile Broadband (eMBB)), machine type communication that implements multiple simultaneous connection (for example, massive Machine Type Communications (mMTC), Internet of Things (IoT)), and high-reliable and low-latency communication (for example, Ultra-Reliable and Low-Latency Communications (URLLC)), are assumed. For example, in URLLC, lower latency and higher reliability in comparison to eMBB are required.

The traffic type may be identified based on at least one of the following in a physical layer.
Logical channel having different priority
Modulation and coding scheme (MCS) table (MCS index table)
Channel quality indication (CQI) table
DCI format
(Radio network temporary indicator (RNTI (System Information-Radio Network Temporary Identifier))) used for scrambling (masking) of cyclic redundancy check (CRC) bits included in (added to) the DCI (DCI format)
RRC (Radio Resource Control) parameter
Specific RNTI (for example, an RNTI for URLLC, an MCS-C-RNTI, or the like)
Search space
Given field in DCI (for example, a newly added field or reuse of an existing field)

Specifically, the traffic type of an HARQ-ACK (or a PUCCH) for a PDSCH may be determined based on at least one of the following.
An MCS index table used for determination of at least one of a modulation order, a target code rate, and a transport block size (TBS) of the PDSCH (for example, whether or not an MCS index table 3 is used)
An RNTI used for CRC scrambling of DCI used for scheduling of the PDSCH (for example, which of a C-RNTI or an MCS-C-RNTI is used for the CRC scrambling)
Priority configured using higher layer signaling

The traffic type may be associated with communication requirements (requirements or required conditions such as latency and an error rate), a data type (such as voice and data), and the like.

The difference between requirements of URLLC and requirements of eMBB may be that latency of URLLC is lower than latency of eMBB, or may be that the requirements of URLLC include requirements of reliability.

For example, requirements of user (U) plane latency of eMBB may include requirements that downlink U plane latency is 4 ms and uplink U plane latency is 4 ms. In contrast, requirements of U plane latency of URLLC may include requirements that downlink U plane latency is 0.5 ms and uplink U plane latency is 0.5 ms. Requirements of reliability of URLLC may include requirements that a 32-byte error rate is 10⁻⁵ in U plane latency of 1 ms.

As enhanced Ultra Reliable and Low Latency Communications (eURLLC), mainly, enhancement of reliability of traffic for unicast data has been under study. URLLC and eURLLC are hereinafter simply referred to as URLLC when not being distinguished from each other.

### (CSI Report (or Reporting))

In Rel-15 NR, a terminal (also referred to as a user terminal, a User Equipment (UE), or the like) generates (also described as determines, calculates, estimates, measures, or the like) channel state information (CSI), based on a reference signal (RS) (or a resource for the RS), and transmits (also described as reports, feeds back, or the like) the generated CSI to a network (for example, a base station). The CSI may be, for example, transmitted to the base station by using an uplink control channel (for example, a Physical Uplink Control Channel (PUCCH)) or an uplink shared channel (for example, a Physical Uplink Shared Channel (PUSCH)).

The RS used for generation of the CSI may be, for example, at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like.

The CSI-RS may include at least one of a non-zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

The CSI may include at least one parameter (CSI parameter), such as a channel quality indicator (CQI), a precoding matrix indicator (PMI), a CSI-RS resource indicator (CRI), an SS/PBCH block resource indicator (SS/PBCH Block Indicator (SSBRI)), a layer indicator (LI), a rank indicator (RI), L1-RSRP (reference signal received power in layer 1 (Layer 1 Reference Signal Received Power)), L1-RSRQ (Reference Signal Received Quality), L1-SINR (a Signal-to-Noise and Interference Ratio or a Signal to Interference plus Noise Ratio), and an L1-SNR (Signal to Noise Ratio).

As methods of reporting the CSI, (1) a periodic CSI (P-CSI) report, (2) an aperiodic CSI (A-CSI) report, (3) a semi-persistent CSI (SP-CSI) report, and the like have been under study.

The UE may receive information (report configuration information) related to a CSI report, and control the CSI report, based on the report configuration information. The report configuration information may be, for example, a radio resource control (RRC) information element (IE) “CSI-ReportConfig”. Note that, in the present disclosure, the RRC IE may be interchangeably interpreted as an RRC parameter, a higher layer parameter, or the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent CSI report (Semi-Persistent CSI (SP-CSI)) report.

The report quantity information may indicate at least one combination of the CSI parameters (for example, the CRI, the RI, the PMI, the CQI, the LI, the L1-RSRP, and the like).

The resource information may be an ID of the resource for the RS. The resource for the RS may include, for example, a non-zero power CSI-RS resource or SSB, and a CSI-IM resource (for example, a zero power CSI-RS resource).

The frequency domain information may indicate frequency granularity of the CSI report. The frequency granularity may include, for example, a wideband and a subband.

The UE performs channel estimation by using a received RS, and estimates a channel matrix H. The UE feeds back an index (PMI) that is determined based on the estimated channel matrix.

The PMI may indicate a precoder matrix (also simply referred to as a precoder) that the UE considers appropriate for the use for downlink (DL) transmission to the UE. Each value of the PMI may correspond to one precoder matrix. A set of values of the PMI may correspond to a different set of precoder matrices referred to as a precoder codebook (also simply referred to as a codebook).

CSI feedback on the above-described traffic types (for example, URLLC, IoT, and the like) has been under study. For example, in order to satisfy URLLC requirements, enhancement of CSI feedback (report) for more accurate selection of a modulation and coding scheme (MCS) has been under study.

When the CSI report for URLLC is based on periodically transmitted P-CSI, configuration of short periodicity of P-CSI report is considered. At the same time, such configuration of short periodicity of P-CSI leads to increase in UL overhead and UE power consumption. When URLLC traffic sporadically occurs, it is also considered that unnecessary P-CSI report may be increased.

Thus, it is considered that CSI feedback for URLLC is performed using the A-CSI.

In existing systems, the A-CSI is carried on only the PUSCH scheduled by a UL grant. When a scenario with many DLs is assumed, many resources for DL transmission are required, and thus it is considered that frequently triggering the A-CSI using the PUSCH is difficult. When the base station fails to acquire the CSI feedback, the base station needs to schedule DL URLLC transmission using the most conservative resource allocation and MCS level. With this, resource use efficiency may be reduced.

Thus, introduction/support of the A-CSI using the PUCCH (A-CSI on PUCCH) has been under study. Specifically, it is preferable that the A-CSI using the PUCCH (A-CSI on PUCCH) be supported separately from the A-CSI using the PUSCH (for example, A-CSI on PUSCH).

The A-CSI using the PUCCH (A-CSI on PUCCH) may be triggered from the base station. The trigger from the base station may be performed using downlink control information (DCI), and at least one of DCI corresponding to a DL grant and DCI corresponding to a UL grant may be applied to the DCI. The DCI corresponding to a DL grant may be at least one of DCI formats 1_0, 1_1, and 1_2. The DCI corresponding to a UL grant may be at least one of DCI formats 0_0, 0_1, and 0_2.

### <Configuration of Priority>

In NR of Rel. 16 or later versions, configuration of a plurality of levels (for example, two levels) of priorities for a given signal or channel has been under study. For example, it is assumed that communication control (for example, transmission control at the time of collision or the like) is performed by configuring different priorities for each of the signals or channels respectively corresponding to different traffic types (also referred to as services, service types, communication types, use cases, or the like). With this, communication can be controlled by configuring different priorities depending on the service type or the like for the same signal or channel.

The priority may be configured for a signal (for example, an HARQ-ACK, UCI such as CSI, a reference signal, or the like), a channel (a PDSCH, a PDCCH, a PUSCH, a PUCCH, or the like), an HARQ-ACK codebook, or the like. The priority may be defined by a first priority (for example, High) and a second priority (for example, Low) of a priority lower than the first priority. Alternatively, three or more types of priorities may be configured. Information related to the priority may be notified from the base station to the UE, using at least one of higher layer signaling and DCI.

For example, the priority may be configured for an HARQ-ACK for a dynamically scheduled PDSCH, an HARQ-ACK for a semi-persistent PDSCH (SPS PDSCH), and an HARQ-ACK for SPS PDSCH release. Alternatively, the priority may be configured for HARQ-ACK codebooks corresponding to these HARQ-ACKs. Note that, when the priority is configured for the PDSCH, the priority of the PDSCH may be interpreted as the priority of the HARQ-ACK for the PDSCH.

When a plurality of UL signals/UL channels collide with each other, the UE may control UL transmission, based on the priority. For example, control may be performed such that UL transmission having a high priority is performed and UL transmission having a low priority is not performed (for example, dropped).

The case in which a plurality of UL signals/UL channels collide with each other may be a case in which resources respectively corresponding to different UL signals/UL channels overlap with each other, or a case in which transmission timings of different UL signals/UL channels overlap with each other. The resources may be, for example, time resources (for example, OFDM symbols), or time resources and frequency resources. “To collide” may be interpreted as “to overlap”. The collision of a plurality of UL signals/UL channels may be limited to a case in which the plurality of UL signals/UL channels are transmitted in the same carrier.

When the priority is notified using DCI, whether or not a bit field (for example, a Priority indicator) for giving a notification of the priority is configured for the DCI may be notified or configured from the base station to the UE by using higher layer signaling. When the DCI does not include the bit field for giving a notification of the priority, the UE may determine that the priority of the PDSCH scheduled using the DCI (or the HARQ-ACK corresponding to the PDSCH) is a specific priority (for example, low).

### (Repetition Transmission)

In Rel. 15, repetition transmission is supported in data transmission. For example, a base station (a network (NW), a gNB) repeats transmission of DL data (for example, a downlink shared channel (PDSCH)) given times. Alternatively, a UE repeats transmission of UL data (for example, an uplink shared channel (PUSCH)) given times.

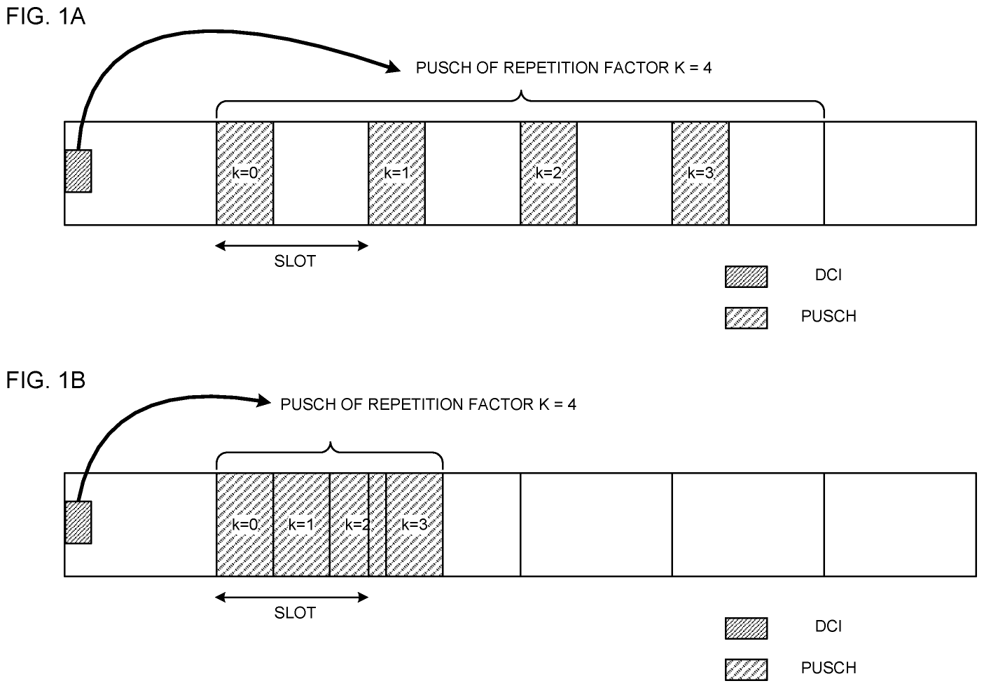

FIG. 1A is a diagram to show an example of repetition transmission of PUSCH. FIG. 1A shows an example in which a given number of repetitions of the PUSCH is scheduled by single DCI. The number of repetitions is also referred to as a repetition factor K or an aggregation factor K.

In FIG. 1A, repetition factor K=4. However, a value of K is not limited thereto. An n-th repetition is also referred to as an n-th transmission occasion or the like, and may be identified by a repetition index k (0≤k≤K−1). FIG. 1A shows repetition transmission of PUSCH dynamically scheduled by DCI (for example, dynamic grant-based PUSCH). However, this may be applied to repetition transmission of configured grant-based PUSCH.

For example, in FIG. 1A, the UE receives information (for example, aggregationFactorUL or aggregationFactorDL) indicating the repetition factor K, using higher layer signaling. Here, the higher layer signaling may be, for example, any one of or a combination of RRC (Radio Resource Control) signaling, MAC (Medium Access Control) signaling, broadcast information, and the like.

For example, the MAC signaling may use a MAC control element (MAC CE), a MAC PDU (Protocol Data Unit), and the like. For example, the broadcast information may be a master information block (MIB), a system information block (SIB), minimum system information (RMSI (Remaining Minimum System Information)), and the like.

The UE controls PDSCH reception processing (for example, at least one of reception, demapping, demodulation, and decoding) or PUSCH transmission processing (for example, at least one of transmission, mapping, modulation, and coding) in K consecutive slots, based on at least one of the following field values (or pieces of information indicated by the field values) in the DCI:
allocation of time domain resources (for example, a start symbol, the number of symbols in each slot, and the like),
allocation of frequency domain resources (for example, a given number of resource blocks (RBs), a given number of resource block groups (RBGs)),
modulation and coding scheme (MCS) index,
configuration of a PDSCH demodulation reference signal (DMRS),
state of transmission configuration indication (or Transmission Configuration Indicator (TCI)) (TCI state (TCI-state)).

Among the K consecutive slots, the same symbol allocation may be applied. FIG. 1A shows a case in which the PUSCH in each slot is allocated to a given number of symbols from the start of the slot. The same symbol allocation among the slots may be determined as described in the time domain resource allocation.

For example, the UE may determine symbol allocation in each slot, based on the start symbol S and the number L of symbols determined based on a value m of a given field (for example, a TDRA field) in the DCI. Note that the UE may determine a first slot, based on K2 information determined based on the value m of the given field (for example, the TDRA field) in the DCI.

In contrast, among the K consecutive slots, a redundancy version (RV) applied to a TB based on the same data may be the same, or may be at least partially different. For example, the RV applied to the TB in the n-th slot (transmission occasion, repetition) may be determined based on a value of a given field (for example, an RV field) in the DCI.

When the resources allocated in the K consecutive slots have, in at least one symbol, a communication direction different from UL, DL, or flexible in each slot indicated by at least one of uplink/downlink communication direction indication information for TDD control (for example, RRC IEs “TDD-UL-DL-ConfigCommon” and “TDD-UL-DL-ConfigDedicated”) and a slot format indicator of DCI (for example, DCI format 2_0), the resources of the slot including the symbol may not be transmitted (or received).

In Rel. 15, as shown in FIG. 1A, PUSCHs are repeatedly transmitted over a plurality of slots (unit of a slot), whereas in Rel. 16 or later versions, it is assumed that repetition transmission of PUSCH is performed in a unit shorter than a slot (for example, a unit of a sub-slot, a unit of a mini-slot, or a unit of a given number of symbols) (see FIG. 1B).

For example, the UE performs a plurality of PUSCH transmissions in one slot. When repetition transmission is performed in a unit of a sub-slot, one transmission of a plurality of repetition transmissions may cross a slot-boundary, depending on the number (for example, K) of repetition transmissions, a unit of allocation of data (data length of each repetition transmission), and the like. In FIG. 1B, the PUSCH of k=2 is mapped across the slot-boundary. In such a case, the PUSCH may be transmitted being divided (or segmented) with respect to the slot-boundary.

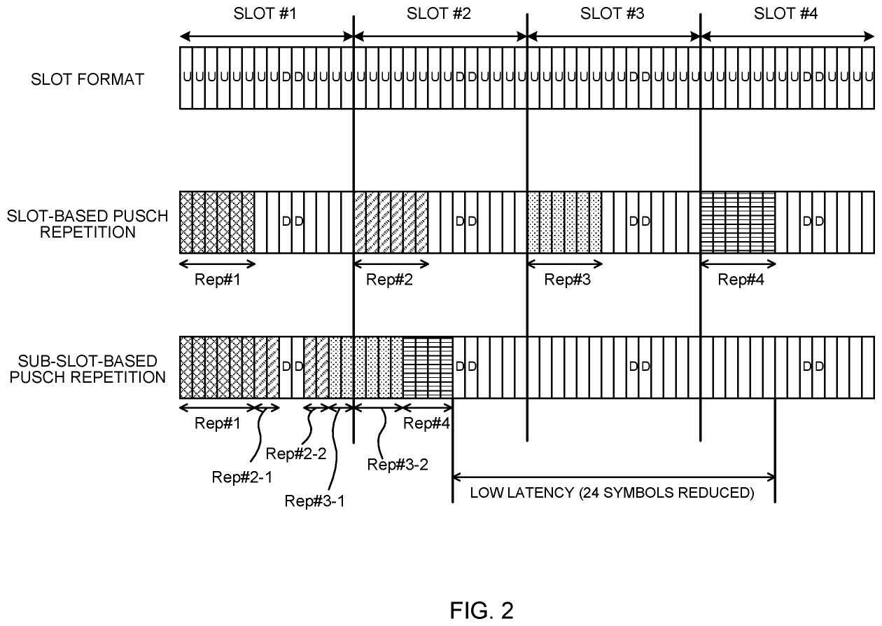

It is assumed that a symbol that is unavailable for PUSCH transmission (for example, a DL symbol, an invalid symbol, or the like) may be included in a slot. In such a case, it is assumed that the PUSCH transmission is performed using symbols except the DL symbol. For example, when given PUSCH-allocated symbols include a DL symbol in a central symbol, PUSCH transmission may be performed so as not to allocate the PUSCH in the part corresponding to the DL symbol. In this case, the PUSCH may be divided (or segmented) (see FIG. 2).

FIG. 2 shows a case in which the PUSCH of k=1 (Rep #2) is divided into two (Reps #2-1 and #2-2) by the DL symbol, and the PUSCH of k=2 (Rep #3) is divided into two (Reps #3-1 and #3-2) by the slot-boundary in sub-slot-based repetition transmission. Note that the sub-slot-based repetition transmission as shown in FIG. 2 may be referred to as repetition transmission type B (for example, PUSCH repetition Type B).

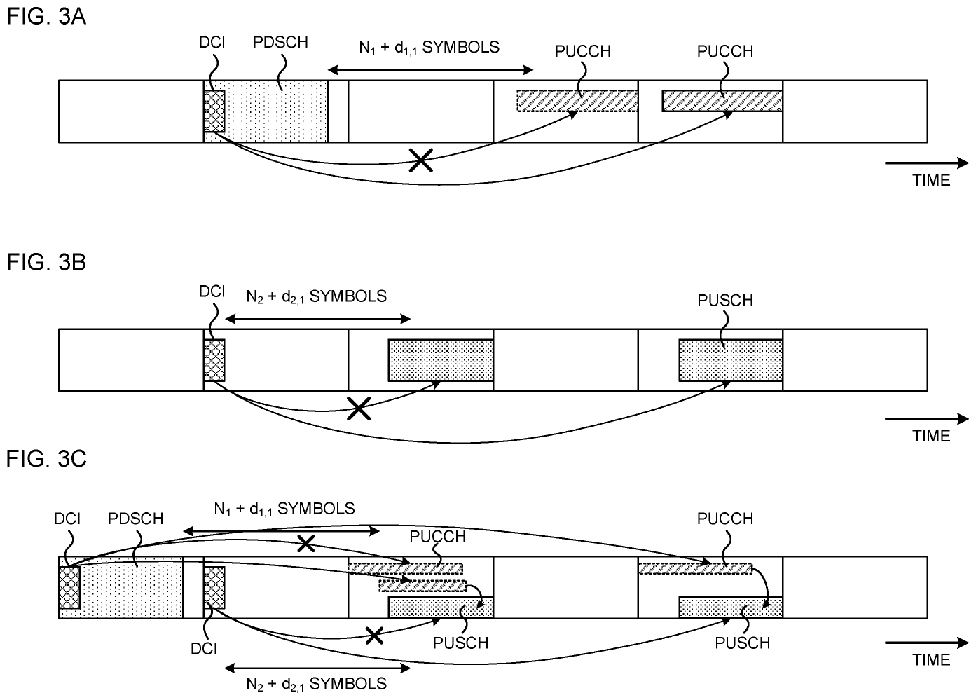

Repetition transmission before the DL symbol, the invalid symbol, or the slot-boundary is taken into consideration (or before being divided/segmented) may be referred to as nominal repetitions or nominal PUSCH repetitions. Repetition transmission (FIG. 3B) that takes the DL symbol, the invalid symbol, or the slot-boundary into consideration (or after being divided/segmented) may be referred to as actual repetitions or actual PUSCH repetitions.

By performing the sub-slot-based repetition transmission of the PUSCH, repetition transmission of the PUSCH can be completed sooner in comparison to a case in which repetition transmission is performed in a unit of a slot.

FIG. 2 shows a case in which, as a slot format, UL symbols (U) and DL symbols (D) are reported. However, other formats (for example, flexible symbols (F) with no explicit indication of DL or UL symbols) may be reported. The UE may perform UL transmission or DL transmission in the flexible symbol, or may perform specific operation (or specific operation may be limited). Information related to the slot format may be reported using at least one of higher layer signaling and DCI (for example, dynamic SFI).

### (Timeline)

In transmission of the PUCCH/PUSCH, the UE may control to actually perform transmission of the PUCCH/PUSCH when a given timeline is satisfied. In this case, the UE may assume that transmission of the PUCCH/PUSCH not satisfying the given timeline is not configured/scheduled.

FIG. 3A is a diagram to show an example of a timeline required for the PUCCH. Here, a case is shown in which the DCI for scheduling the PDSCH indicates the PUCCH (or PUCCH resources) used for transmission of UCI (for example, an HARQ-ACK corresponding to the PDSCH).

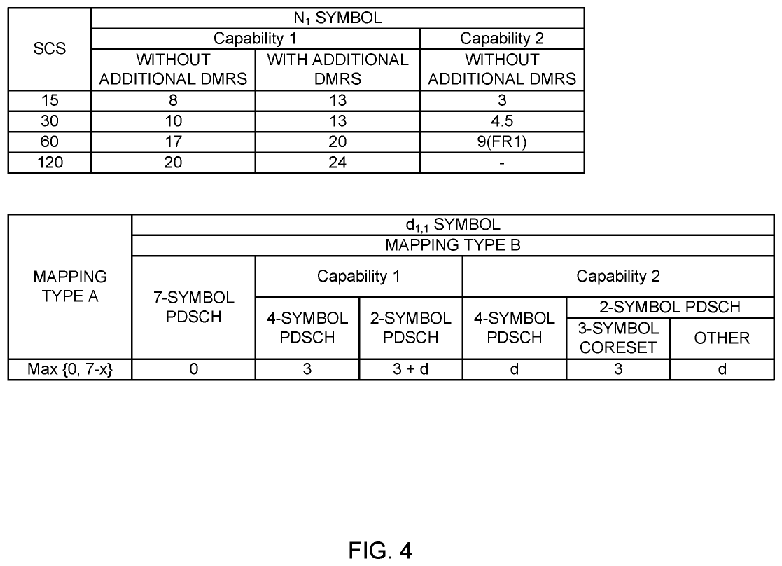

When there is a given period or more between the PDSCH scheduled by the DCI (for example, a last symbol of the PDSCH) and the PUCCH (for example, a start symbol of the PUCCH), the UE may perform transmission of the PUCCH. The given period (for example, given symbols) may be determined based on a parameter (N₁), which is determined based on at least one of a subcarrier spacing, UE capability, and presence or absence of an additional DMRS, and a parameter (d_{1,1}), which is determined based on at least one of a mapping type and UE capability (see FIG. 4). For example, the given period may be N₁+d_{1,1} symbols.

FIG. 3B is a diagram to show an example of a timeline required for the PUSCH. Here, a case is shown in which the DCI schedules the PUSCH.

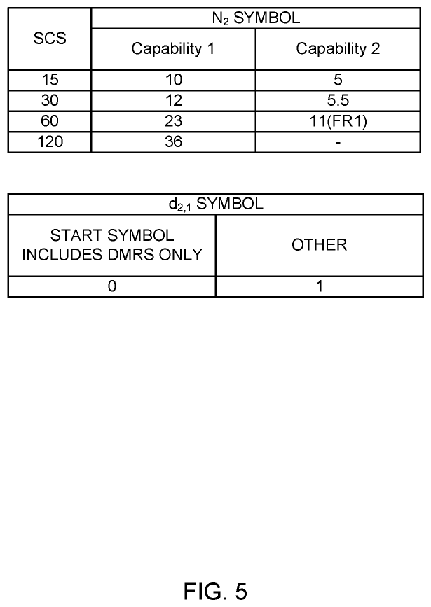

When there is a given period or more between the DCI (for example, a last symbol of the PDCCH used for transmission of the DCI) and the PUSCH (for example, a start symbol of the PUSCH), the UE may perform transmission of the PUSCH. The given period (for example, given symbols) may be determined based on a parameter (N₂), which is determined based on at least one of a subcarrier spacing and UE capability, and a parameter (d_{2,1}), which is determined based on a configuration of the start symbol of the PUSCH (see FIG. 5). For example, the given period may be N₂+d_{2,1} symbols.

When at least part of transmission periods/resources of a plurality of UL channels (or UL transmissions) overlaps, and a given condition is satisfied, a UL signal scheduled to be transmitted on another UL channel may be multiplexed on/mapped to a specific UL channel. The given condition may be priority. For example, when the priority is the same, the plurality of UL transmissions may be performed using the specific UL channel. Note that the given condition is not limited to the priority, and another condition may be taken into consideration in addition to the priority, or another condition may be taken into consideration instead of the priority.

For example, when the PUCCH and the PUSCH having the same priority overlap in the time domain, the UE may transmit UCI scheduled to be transmitted on the PUCCH by using the PUSCH (or by multiplexing/mapping the UCI on/to the PUCCH). In this case, the multiplexing/mapping may be permitted when both of the PUCCH transmission and the PUSCH transmission satisfy their respective timelines (see FIG. 3C).

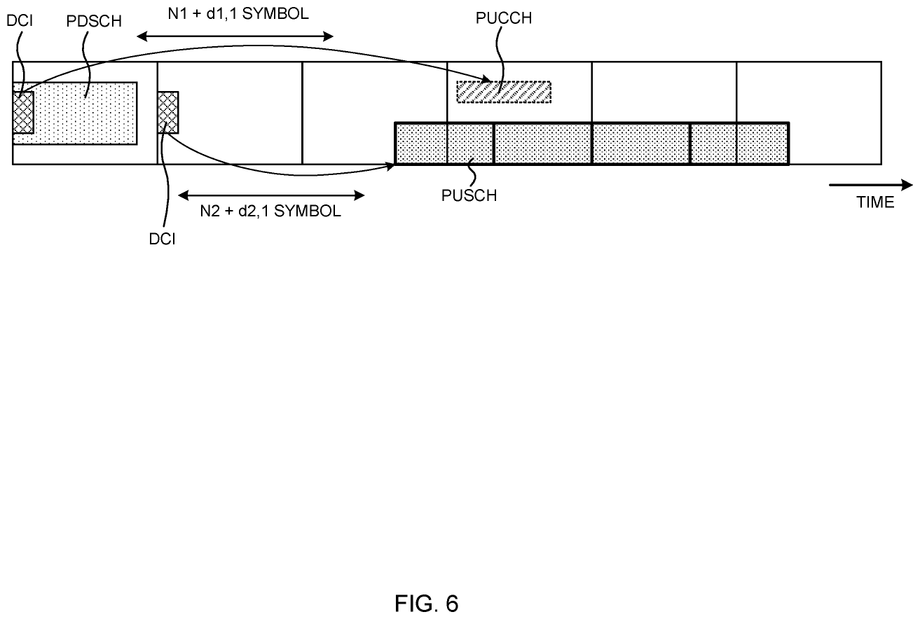

As described above, it is also considered that one or more PUSCHs (or repetition transmission of the PUSCHs) to which repetition transmission type B (for example, PUSCH repetition Type B) is applied and the PUCCH overlap in the time domain (see FIG. 6). In this case, it is considered that the UE UCI-multiplexes/maps the PUCCH (or UCI scheduled to be transmitted on the PUCCH) on/to only one PUSCH (for example, Actual PUSCH repetition) that actually overlaps the PUCCH.

In contrast, when A-CSI transmission (or A-CSI report) using the PUCCH is supported/introduced, how to control UL transmission when the PUCCH and the PUSCH overlap has not been fully studied. Unless the CSI report is appropriately performed, communication quality may be deteriorated.

The inventors of the present invention focused on a case in which the A-CSI report using the PUCCH and another UL transmission collide, studied how to control the UL transmission in the case, and came up with the idea of the present embodiment.

Embodiments according to the present disclosure will be described in detail with reference to the drawings as follows. The aspects to be described below may each be employed individually, or may be employed in combination. In the present disclosure, A/B may be interpreted as at least one of A and B, and A/B/C may be interpreted as at least one of A, B, and C.

The following description takes an example in which the priority has two levels (x=2), i.e., a first priority (High) and a second priority (Low). However, the number and types of priorities are not limited thereto. Three or more types (or three or more levels) of priorities may be applied. The priority configured for each signal or channel may be configured for the UE by using higher layer signaling or the like.

The following description takes an example in which a plurality of service types have two types, i.e., eMBB and URLLC. However, the types and number of service types are not limited thereto. The service types may be configured in association with the priorities. In the following description, “to drop” may be interpreted as “to cancel” or “to not transmit”.

In the present disclosure, a cell, a CC, a carrier, a BWP, and a band may be interchangeably interpreted. In the present disclosure, an index, an ID, an indicator, and a resource ID may be interchangeably interpreted. In the present disclosure, an RRC parameter, a higher layer parameter, an RRC information element (IE), and an RRC message may be interchangeably interpreted.

The following description takes an example of a case in which the A-CSI report using the PUCCH collides with another UL transmission. However, the present embodiment may be applied to a signal/channel other than the A-CSI report. For example, the present embodiment may be applied to P-CSI or SP-CSI using the PUCCH, or may be applied to other UCI different from the CSI.

The following description shows a case in which a plurality of UL channels/UL transmissions overlap in the time domain (or the time resources) in the same cell (or carrier, CC, or BWP). However, this is not restrictive. The present embodiment may be applied to a case in which a plurality of UL channels/UL transmissions overlap in the time domain (or the time resources) in different cells (or carriers, CCs, or BWPs).

### (First Aspect)

A first aspect will describe a UL transmission method (for example, a relationship with another UL transmission and the like) of a case in which A-CSI report/transmission using the PUCCH (for example, A-CSI on PUCCH) is supported. The following description takes an example of PUSCH (for example, PUSCH to which repetition transmission type B is applied) transmission as another UL transmission. However, another UL transmission is not limited thereto.

When the A-CSI report using the PUCCH is supported, the UE may control UL transmission in accordance with the following option 1-1 or option 1-2.

### <Option 1-1>

The A-CSI using the PUCCH may not be multiplexed on/mapped to the PUSCH. In other words, the A-CSI report/transmission using the PUSCH (for example, A-CSI on PUCCH on PUSCH) may not be supported.

The UE need not assume that the A-CSI using the PUCCH and the PUSCH collide in the time domain. In this case, a network (for example, the base station) may perform control so that the PUCCH used for transmission of the A-CSI and another UL transmission (for example, the PUSCH) do not collide in the time domain.

Alternatively, when the A-CSI using the PUCCH (or the PUCCH resources used for A-CSI transmission) and the PUSCH collide in the time domain, the UE may perform control not to perform (for example, to drop) transmission of one of the PUCCH and the PUSCH.

The UE may determine which is to be dropped among the PUCCH and the PUSCH, based on a given condition (for example, at least one of priority and transmission start timing). Alternatively, the UL channel to be dropped may be defined in a specification, or may be reported from the base station to the UE using higher layer signaling/DCI.

### <Option 1-2>

The A-CSI using the PUCCH may be permitted to be multiplexed on/mapped to the PUSCH. In other words, the A-CSI report/transmission using the PUSCH (for example, A-CSI on PUCCH on PUSCH) may be supported.

When the A-CSI using the PUCCH (or the PUCCH resources used for A-CSI transmission) and the PUSCH collide in the time domain, the UE may multiplex/map the A-CSI on/to the PUSCH (for example, A-CSI on PUCCH on PUSCH).

When a given condition is satisfied, the UE may perform control to multiplex/map the A-CSI on/to the PUSCH. The given condition may be priority of the UL channel. For example, when the priority of the PUCCH used for the A-CSI report/transmission (or the priority of the A-CSI) and the priority of the PUSCH are the same, the A-CSI may be multiplexed on/mapped to the PUSCH.

Otherwise (for example, when the priority of the A-CSI using the PUCCH and the priority of the PUSCH are different from each other), one of them (for example, the UL channel whose priority is configured to “low”) may be dropped.

Alternatively, control may be performed so that the PUCCH (or the A-CSI) and the PUSCH having different priorities do not collide in the time domain. In this case, when the PUCCH for A-CSI transmission and the PUSCH collide in the time domain, the UE may assume that the same priority is configured for the PUCCH (or the A-CSI) and the PUSCH.

The priority of the UL channel may be dynamically reported to the UE by using DCI. For example, the DCI triggering the A-CSI using the PUCCH may include information related to the priority of the A-CSI (or the PUCCH). The DCI for scheduling the PUSCH may include information related to the priority of the PUSCH.

Alternatively, the priority of the UL channel may be determined based on a DCI format. For example, in a case of being triggered/scheduled using a first DCI format (for example, DCI format 0_1 or 1_1), the UE may determine that a corresponding UL channel is configured to “low”. In contrast, in a case of being triggered/scheduled using a second DCI format (for example, DCI format 0_2 or 1_2), the UE may determine that a corresponding UL channel is configured to “high”.

Alternatively, the priority of a given UL channel may be reported/configured using higher layer signaling.

Alternatively, the priority of a given UL channel may be defined in a specification. For example, the priority of the A-CSI using the PUCCH (A-CSI on PUCCH) may be defined as either low or high.

When the A-CSI using the PUCCH and another UL channel (for example, the PUSCH) collide in the time domain, performing transmission of the A-CSI by using the PUSCH enables appropriate reporting of the CSI to the base station. With this, a transmission condition and the like can be appropriately configured based on the CSI reported to the base station, and therefore deterioration of communication quality can be prevented.

### (Second Aspect)

A second aspect will describe a control method of UL transmission of a case in which the A-CSI report/transmission using the PUCCH (for example, A-CSI on PUCCH) collides with another UL transmission. The following description takes an example of PUSCH (for example, PUSCH to which repetition transmission type B is applied) transmission as another UL transmission. However, another UL transmission is not limited thereto.

When the PUCCH (or the PUCCH resources) including the A-CSI and the PUSCH to which repetition transmission type B is applied collide in the time domain, the UE may control UL transmission in accordance with the following option 2-1 or option 2-2. In the second aspect, such a case in which the PUCCH including the A-CSI and the PUSCH to which repetition transmission type B is applied collide in the time domain refers to a case in which the PUCCH collides with at least one of one or more PUSCHs (actual repetition).

### <Option 2-1>

When the PUCCH including the A-CSI and the PUSCH to which repetition transmission type B is applied collide in the time domain, the A-CSI may be transmitted using one or a plurality of PUSCHs (actual repetition).

The UE may determine the PUSCH used for transmission of the A-CSI (or the PUSCH on/to which the A-CSI is multiplexed/mapped), based on a given condition. As the given condition, at least one of the following may be taken into consideration: whether or not the A-CSI on the PUCCH is multiplexed on/mapped to non-overlapping PUSCH transmission (non-overlapping repetitions) (condition 1); and on/to which PUSCH transmission (repetition) the A-CSI on the PUCCH is multiplexed/mapped (condition 2).

### [Condition 1]

In condition 1, the following Alt #1 or #2 may be taken into consideration.
Alt #1: The PUSCH used for transmission of the A-CSI is determined regardless of whether or not the PUSCH is overlapped by the PUCCH for the A-CSI.
Alt #2: The PUSCH used for transmission of the A-CSI is limited to the PUSCH (actual repetition) overlapped by the PUCCH for the A-CSI.

When the UE determines the PUSCH on/to which the A-CSI is multiplexed/mapped based on Alt #1, the UE may select one or a plurality of PUSCH transmissions out of a plurality of PUSCH transmissions (actual repetition), regardless of positions of the PUCCH resources for the A-CSI.

When the UE determines the PUSCH on/to which the A-CSI is multiplexed/mapped based on Alt #2, the UE may select one or a plurality of PUSCH transmissions out of a plurality of PUSCH transmissions (actual repetition) by taking positions of the PUCCH resources for the A-CSI into consideration. When the PUCCH resources for the A-CSI overlap a plurality of PUSCH transmissions (actual repetition), the PUSCH on which the A-CSI is multiplexed may be selected based on another condition (for example, condition 2).

### [Condition 2]

In condition 2, the following Alt #A, #B, #C, or #D may be taken into consideration.
Alt #A: The A-CSI on the PUCCH is multiplexed on/mapped to a first PUSCH (actual repetition) in a first slot.
Alt #B: The A-CSI on the PUCCH is multiplexed on/mapped to a first PUSCH (actual repetition) in each slot.
Alt #C: The A-CSI on the PUCCH is multiplexed on/mapped to one or a plurality of PUSCHs (actual repetition) of a given size or larger.
Alt #D: The A-CSI on the PUCCH is multiplexed on/mapped to the PUSCH (actual repetition) having the largest (or the longest) number of OFDM symbols (or PUSCH length).

When the UE determines the PUSCH on/to which the A-CSI is multiplexed/mapped based on Alt #A, the UE selects the first PUSCH (actual repetition) in the first slot. The first slot may be determined based on another condition (for example, condition 1).

When the UE determines the PUSCH on/to which the A-CSI is multiplexed/mapped based on Alt #3, the UE may determine each slot, based on another condition (for example, condition 1).

When the UE determines the PUSCH on/to which the A-CSI is multiplexed/mapped based on Alt #C, the UE selects the PUSCH (actual repetition) of a given size required for multiplexing/mapping of the A-CSI or larger. The given size may be the number of resource elements (for example, REs that can be used for A-CSI transmission) of the PUSCH.

In other words, the UE may select one or a plurality of PUSCHs (actual repetition) having a number of REs larger than the number of REs required for A-CSI transmission. When one PUSCH is selected, the PUSCH may be the PUSCH located at the start in the time domain. When other UCI, in addition to the A-CSI, is transmitted using the PUCCH, the given size may be the number of REs necessary for transmission of the pieces of UCI including both of the A-CSI and such other UCI.

When there is no PUSCH transmission satisfying the size (or capacity, resources) required for multiplexing/mapping of the UCI including the A-CSI, control may be performed not to perform transmission of the A-CSI using the PUSCH. In this case, the UE may perform control to drop the PUSCH (actual PUSCH) overlapping the PUCCH for the A-CSI and transmit the PUCCH. The PUSCH to be dropped may be only the PUSCH overlapping the PUCCH in the time domain, or may be the whole PUSCH repetition.

Alternatively, the UE may perform control to drop the PUCCH used for A-CSI transmission and perform PUSCH transmission.

When there is no PUSCH transmission satisfying the requirement of the size (or capacity, resources) among the PUSCHs as candidates on/to which the A-CSI is multiplexed/mapped with condition 1/condition 2 (Alt #C) being taken into consideration, the A-CSI may be multiplexed on/mapped to PUSCH transmission other than the candidates. For example, when there are a plurality of PUSCH transmissions satisfying the requirement of the size, the UE may perform control to multiplex/map the A-CSI on/to at least one of a first PUSCH in the time domain or a PUSCH having the largest size.

In Alt #ID, when there are a plurality of PUSCHs having the largest (or the longest) number of OFDM symbols (or PUSCH length), a first PUSCH in the time domain may be selected.

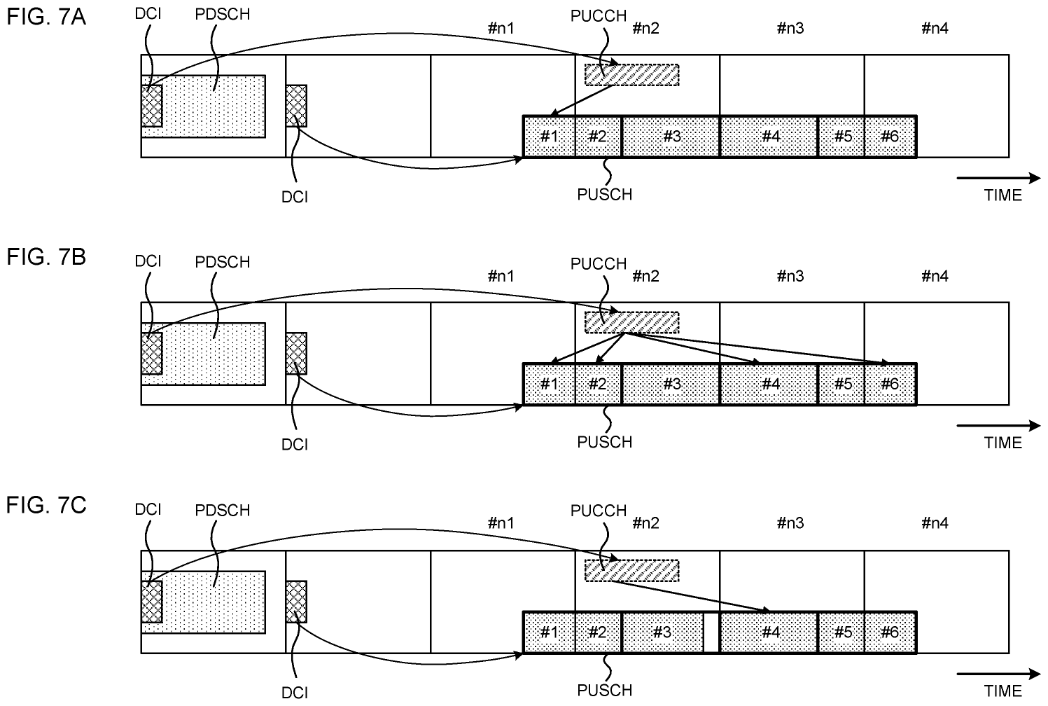

FIG. 7A is a diagram to show an example of a case in which the PUSCH used for transmission of the A-CSI is determined based on Alt #1 of condition 1 and Alt #A of condition 2. FIG. 7A shows a case in which the PUSCH to which repetition transmission type B is applied is repeatedly transmitted over slots #n1 to #n4.

Here, a case is shown in which slot #n1 includes PUSCH #1, slot #n2 includes PUSCHs #2 and #3, slot #n3 includes PUSCHs #4 and #5, and slot #n4 includes PUSCH #6. A case is shown in which the PUCCH for the A-CSI is configured/scheduled in slot #n2, and overlaps PUSCHs #2 and #3. Each of PUSCHs #1 and #2 and PUSCHs #5 and #6 may be segmented PUSCH transmission.

In FIG. 7A, multiplexing on/mapping to the PUSCH not overlapping the PUCCH for the A-CSI is permitted (Alt #1), and the first PUSCH of the first slot is selected (Alt #A), and accordingly, the A-CSI is multiplexed on/mapped to PUSCH #1. In this case, the A-CSI can be transmitted using the first PUSCH in the time domain, and therefore low latency can be achieved.

FIG. 7B is a diagram to show an example of a case in which the PUSCH used for transmission of the A-CSI is determined based on Alt #1 of condition 1 and Alt #B of condition 2. In FIG. 7B, multiplexing on/mapping to the PUSCH not overlapping the PUCCH for the A-CSI is permitted (Alt #1), and the first PUSCH of each slot is selected (Alt #B), and accordingly, the A-CSI is multiplexed on/mapped to PUSCHs #1, #2, #4, and #6. In this case, the A-CSI is transmitted using the first PUSCH in the time domain, and the A-CSI can be transmitted using a plurality of PUSCHs, and therefore low latency and reliability enhancement can be achieved.

When the A-CSI is multiplexed on/mapped to a plurality of PUSCHs, the same A-CSI may be multiplexed on/mapped to each of the PUSCHs.

FIG. 7C is a diagram to show an example of a case in which the PUSCH used for transmission of the A-CSI is determined based on Alt #1 of condition 1 and Alt #D of condition 2. FIG. 7C shows a case in which a DL or an invalid symbol is configured for a last symbol of slot #n2, and the number of symbols of PUSCH #3 is reduced less than the number of symbols of PUSCH #4.

In FIG. 7C, multiplexing on/mapping to the PUSCH not overlapping the PUCCH for the A-CSI is permitted (Alt #1), and the PUSCH having the largest (or the longest) number of OFDM symbols (or PUSCH length) is selected (Alt #ID), and accordingly, the A-CSI is multiplexed on/mapped to PUSCH #4. In this case, even when the size of the UCI including the A-CSI is large, transmission can be appropriately performed.

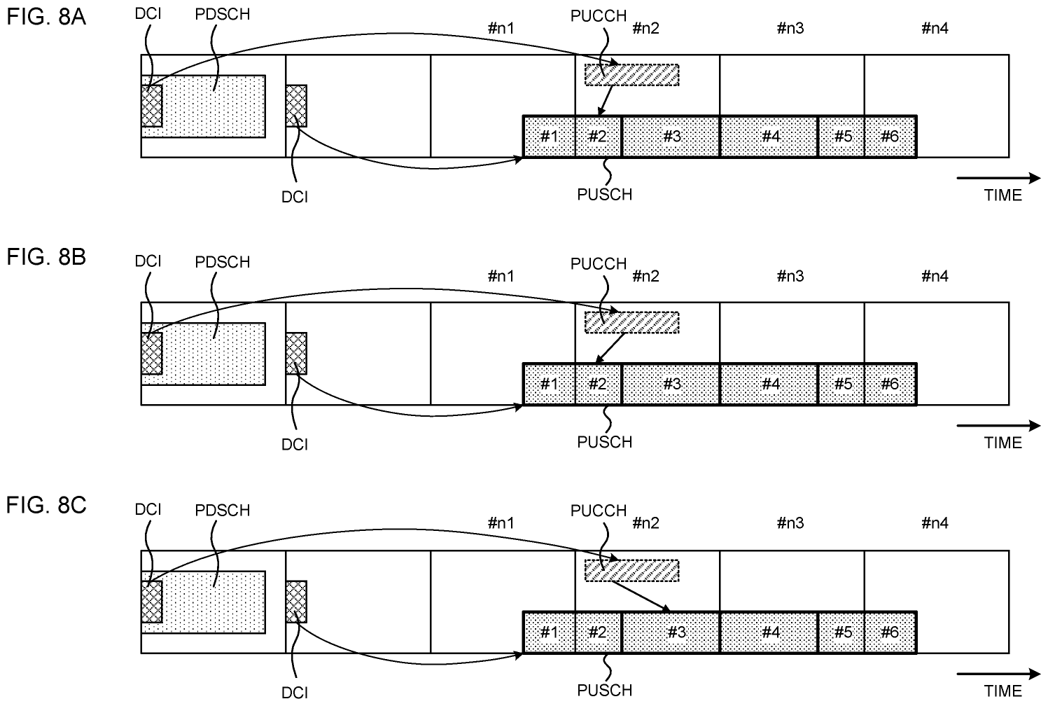

FIG. 8A is a diagram to show an example of a case in which the PUSCH used for transmission of the A-CSI is determined based on Alt #2 of condition 1 and Alt #A of condition 2. FIG. 8A shows a case in which the PUSCH to which repetition transmission type B is applied is repeatedly transmitted over slots #n1 to #n4.

Here, a case is shown in which slot #n1 includes PUSCH #1, slot #n2 includes PUSCHs #2 and #3, slot #n3 includes PUSCHs #4 and #5, and slot #n4 includes PUSCH #6. A case is shown in which the PUCCH for the A-CSI is configured/scheduled in slot #n2, and overlaps PUSCHs #2 and #3. Each of PUSCHs #1 and #2 and PUSCHs #5 and #6 may be segmented PUSCH transmission.

In FIG. 8A, multiplexing on/mapping to the PUSCH not overlapping the PUCCH for the A-CSI is not permitted (Alt #2), and the first PUSCH of the first slot is selected (Alt #A), and accordingly, the A-CSI is multiplexed on/mapped to PUSCH #2. In this case, the A-CSI can be transmitted using the first PUSCH in the time domain among overlapping PUSCHs, and therefore low latency can be achieved.

FIG. 8B is a diagram to show an example of a case in which the PUSCH used for transmission of the A-CSI is determined based on Alt #2 of condition 1 and Alt #B of condition 2. In FIG. 8B, multiplexing on/mapping to the PUSCH not overlapping the PUCCH for the A-CSI is not permitted (Alt #2), and the first PUSCH of each slot is selected (Alt #B), and accordingly, the A-CSI is multiplexed on/mapped to PUSCH #2.

FIG. 8C is a diagram to show an example of a case in which the PUSCH used for transmission of the A-CSI is determined based on Alt #2 of condition 1 and Alt #D of condition 2. In FIG. 8C, multiplexing on/mapping to the PUSCH not overlapping the PUCCH for the A-CSI is not permitted (Alt #2), and the PUSCH having the largest (or the longest) number of OFDM symbols (or PUSCH length) is selected (Alt #ID), and accordingly, the A-CSI is multiplexed on/mapped to PUSCH #3. In this case, even when the size of the UCI including the A-CSI is large, transmission can be appropriately performed.

### <Option 2-2>

When the PUCCH including the A-CSI and the PUSCH to which repetition transmission type B is applied collide in the time domain, the A-CSI may be transmitted using all of PUSCHs (actual repetition) satisfying a given condition.

As the given condition, whether or not the A-CSI on the PUCCH is multiplexed on/mapped to non-overlapping PUSCH transmission (non-overlapping repetitions) may be taken into consideration.

For example, the following Alt #1 or #2 may be taken into consideration.
Alt #1: The PUSCH used for transmission of the A-CSI is determined regardless of whether or not the PUSCH is overlapped by the PUCCH for the A-CSI.
Alt #2: The PUSCH used for transmission of the A-CSI is limited to the PUSCH (actual repetition) overlapped by the PUCCH for the A-CSI.

When the UE determines the PUSCH on/to which the A-CSI is multiplexed/mapped based on Alt #1, the UE may select all of PUSCH transmissions, regardless of positions of the PUCCH resources for the A-CSI.

When the UE determines the PUSCH on/to which the A-CSI is multiplexed/mapped based on Alt #2, the UE may select one or a plurality of PUSCH transmissions out of a plurality of PUSCH transmissions (actual repetition) by taking positions of the PUCCH resources for the A-CSI into consideration. When the PUCCH resources for the A-CSI overlap a plurality of PUSCH transmissions (actual repetition), the plurality of PUSCHs may be selected.

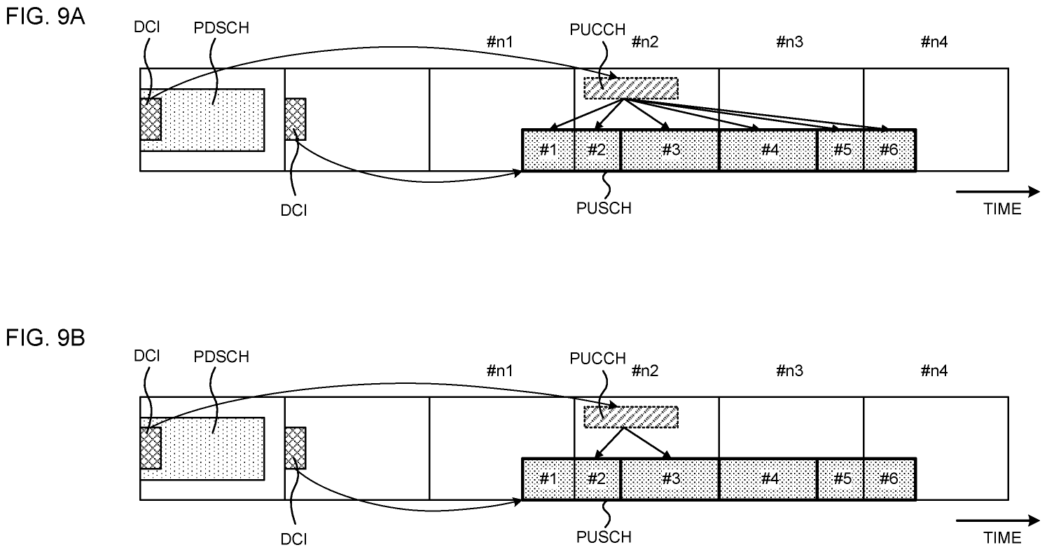

FIG. 9A is a diagram to show an example of a case in which the PUSCH used for transmission of the A-CSI is determined based on Alt #1. FIG. 9A shows a case in which the PUSCH to which repetition transmission type B is applied is repeatedly transmitted over slots #n1 to #n4.

Here, a case is shown in which slot #n1 includes PUSCH #1, slot #n2 includes PUSCHs #2 and #3, slot #n3 includes PUSCHs #4 and #5, and slot #n4 includes PUSCH #6. A case is shown in which the PUCCH for the A-CSI is configured/scheduled in slot #n2, and overlaps PUSCHs #2 and #3. Each of PUSCHs #1 and #2 and PUSCHs #5 and #6 may be segmented PUSCH transmission.

In FIG. 9A, multiplexing on/mapping to the PUSCH not overlapping the PUCCH for the A-CSI is permitted (Alt #1), and accordingly, the A-CSI is multiplexed on/mapped to PUSCHs #1, #2, #3, #4, #5, and #6. In this case, the A-CSI is transmitted using the first PUSCH in the time domain, and the A-CSI can be transmitted using a plurality of PUSCHs, and therefore low latency and reliability enhancement can be achieved.

In FIG. 9B, multiplexing on/mapping to the PUSCH not overlapping the PUCCH for the A-CSI is not permitted (Alt #2), and accordingly, the A-CSI is multiplexed on/mapped to PUSCHs #2 and #3 overlapping the PUCCH. In this case, the A-CSI can be transmitted using a plurality of PUSCHs, and therefore reliability enhancement can be achieved.

### (Third Aspect)

A third aspect will describe a control method of UL transmission of a case in which the A-CSI report/transmission using the PUCCH (for example, A-CSI on PUCCH) collides with another UL transmission, which is a control method different from that of the second aspect. The following description takes an example of PUSCH (for example, PUSCH to which repetition transmission type B is applied) transmission as another UL transmission. However, another UL transmission is not limited thereto.

In the second aspect, collision/multiplexing between the PUCCH and the PUSCH is determined based on a segmented (or actually transmitted) PUSCH (actual repetition) as the repeatedly transmitted PUSCH, whereas in the third aspect, collision/multiplexing between the PUCCH and the PUSCH is determined based on an unsegmented PUSCH (nominal repetition).

When the PUCCH (or the PUCCH resources) including the A-CSI and the PUSCH to which repetition transmission type B is applied collide in the time domain, the UE may control UL transmission in accordance with the following option 3-1 or option 3-2.

### <Option 3-1>

When the PUCCH including the A-CSI and the PUSCH to which repetition transmission type B is applied collide in the time domain, the A-CSI may be transmitted using one or a plurality of PUSCHs (nominal repetition).

When the PUSCH (nominal repetition) overlapping the PUCCH is segmented/divided into a plurality of PUSCHs (actual repetition), the UE may determine the PUSCH (actual repetition) to be used for transmission of the A-CSI, based on a given condition. The given condition may be, for example, at least one condition (option 2-1 (for example, at least one of Alts #1 to #2 and Alts #A to #D), option 2-2) shown in the second aspect.

Note that, when the PUCCH overlaps a plurality of PUSCHs (nominal repetition), one PUSCH (nominal repetition) may be selected. In this case, a first PUSCH (nominal repetition) in the time domain may be selected, or an unsegmented/divided PUSCH may be selected.

Alternatively, when the PUSCH (nominal repetition) overlapping the PUCCH is segmented/divided into a plurality of PUSCHs (actual repetition), the UE may perform control not to multiplex the A-CSI on the PUSCH (for example, nominal repetition). In this case, the UE may drop the A-CSI (or the PUCCH). Alternatively, the UE may drop the PUSCH (for example, nominal repetition or actual repetition) overlapping the A-CSI (or the PUCCH).

Information related to the number of PUSCHs (nominal repetition) on which the A-CSI is to be multiplexed may be reported from the base station to the UE, using DCI/higher layer signaling. The UE may determine the number of PUSCHs (nominal repetition) on which the A-CSI is to be multiplexed, based on the reporting/configuration from the base station. When there is no reporting/configuration from the base station, a given value/default value may be applied as the number of PUSCHs (nominal repetition) to which the A-CSI is to be multiplexed. The given value/default value may be 1, for example.

### <Option 3-2>

When the PUCCH including the A-CSI and the PUSCH to which repetition transmission type B is applied collide in the time domain, the A-CSI may be transmitted using all of PUSCHs (nominal repetition) satisfying a given condition.

As the given condition, whether or not the A-CSI on the PUCCH is multiplexed on/mapped to non-overlapping PUSCH transmission (non-overlapping repetitions) may be taken into consideration.

For example, the following Alt #1 or #2 may be taken into consideration.
Alt #1: The PUSCH used for transmission of the A-CSI is determined regardless of whether or not the PUSCH is overlapped by the PUCCH for the A-CSI.
Alt #2: The PUSCH used for transmission of the A-CSI is limited to the PUSCH (nominal repetition) overlapped by the PUCCH for the A-CSI.

When the UE determines the PUSCH on/to which the A-CSI is multiplexed/mapped based on Alt #1, the UE may select all of PUSCH (nominal repetition) transmissions, regardless of positions of the PUCCH resources for the A-CSI.

When the UE determines the PUSCH on/to which the A-CSI is multiplexed/mapped based on Alt #2, the UE may select one or a plurality of PUSCH transmissions out of a plurality of PUSCH transmissions (nominal repetition) by taking positions of the PUCCH resources for the A-CSI into consideration. When the PUCCH resources for the A-CSI overlap a plurality of PUSCH transmissions (nominal repetition), the plurality of PUSCHs may be selected.

When the PUSCH (nominal repetition) overlapping the PUCCH is segmented/divided into a plurality of PUSCHs (actual repetition), the UE may determine the PUSCH (actual repetition) to be used for transmission of the A-CSI, based on a given condition. The given condition may be, for example, at least one condition (option 2-1 (for example, at least one of Alts #1 to #2 and Alts #A to #D), option 2-2) shown in the second aspect.

Alternatively, when the PUSCH (nominal repetition) overlapping the PUCCH is segmented/divided into a plurality of PUSCHs (actual repetition), the UE may perform control not to multiplex the A-CSI on the PUSCH (for example, nominal repetition). In this case, the UE may drop the A-CSI (or the PUCCH). Alternatively, the UE may drop the PUSCH (for example, nominal repetition or actual repetition) overlapping the A-CSI (or the PUCCH).

### (Fourth Aspect)

A fourth aspect will describe a timeline of a case (for example, A-CSI on PUCCH on PUSCH) in which the A-CSI transmitted using the PUCCH is multiplexed on/mapped to the PUSCH.

The UE may determine whether or not the A-CSI transmitted using the PUCCH is multiplexed on/mapped to the PUSCH, based on at least one of a timeline for the A-CSI (or the PUCCH) and a timeline for the PUSCH.

For example, only when all of PUSCH (actual repetition) transmissions overlapping the PUCCH for the A-CSI satisfy a given timeline, the UE may perform control to multiplex/map the A-CSI on/to the PUSCH (option 1). Otherwise (for example, when a given timeline is not satisfied), the UE may perform control not to multiplex/map the A-CSI on/to the PUSCH (or determine that it is an error case).

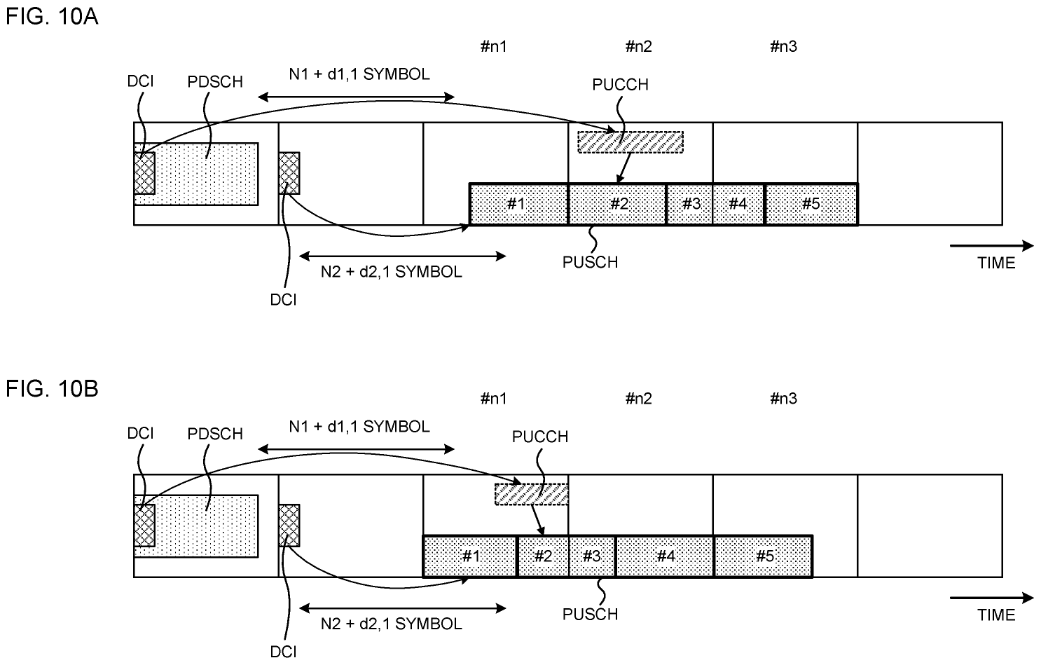

FIG. 10A shows an example of a case in which a given timeline is satisfied, and FIG. 10B shows an example of a case in which a given timeline is not satisfied. FIGS. 10A and 10B show a case in which the PUSCH to which repetition transmission type B is applied is repeatedly transmitted over slots #n1 to #n3.

FIG. 10A shows a case in which slot #n1 includes PUSCH #1, slot #n2 includes PUSCHs #2 and #3, and slot #n3 includes PUSCHs #4 and #5. A case is shown in which the PUCCH for the A-CSI is configured/scheduled in slot #n2, and overlaps PUSCHs #2 and #3. PUSCHs #3 and #4 may be segmented PUSCH transmission.

FIG. 10B shows a case in which slot #n1 includes PUSCHs #1 and #2, slot #n2 includes PUSCH #3 and #4, and slot #n3 includes PUSCH #5. A case is shown in which the PUCCH for the A-CSI is configured/scheduled in slot #n1, and overlaps PUSCHs #1 and #2. PUSCHs #2 and #3 may be segmented PUSCH transmission.

In FIG. 10A, a period between the PUCCH for the A-CSI and the DCI for configuring/triggering the PUCCH satisfies a first timeline (for example, N₁+d_{1,1} symbols or more). A period between all of PUSCHs (for example, PUSCHs #2 and #3) overlapping the PUCCH and the DCI for scheduling the PUSCH satisfies a second timeline (for example, N₂+d_{2,1} symbols or more).

In FIG. 10B, a period between the PUCCH for the A-CSI and the DCI for configuring/triggering the PUCCH satisfies the first timeline (for example, N₁+d_{1,1} symbols or more). In contrast, a period between a part of the PUSCHs (for example, PUSCH #1) overlapping the PUCCH and the DCI for scheduling the PUSCH does not satisfy the second timeline (for example, less than N₂+d_{2,1} symbols).

In the case of FIG. 10A, the UE may perform control to multiplex/map the A-CSI on/to the PUSCH, and in the case of FIG. 10B, the UE may perform control not to multiplex/map the A-CSI on/to the PUSCH (or determine that it is an error case).

Alternatively, even when all of PUSCH (actual repetition) transmissions overlapping the PUCCH for the A-CSI do not satisfy the given timeline (FIG. 10B), the UE may perform control to multiplex/map the A-CSI on/to the PUSCH (option 2). The UE may perform control to multiplex/map the A-CSI on/to a given PUSCH in the case of FIG. 10A and in the case of FIG. 10B.

In the case of FIG. 10B, the UE may select the PUSCH satisfying the given timeline as the PUSCH (actual repetition) on which the A-CSI is to be multiplexed. For example, in the case of FIG. 10B, the UE may perform control to multiplex/map the A-CSI on/to the PUSCH (at least one of PUSCH #2 and subsequent PUSCHs) satisfying the second timeline. With this, the A-CSI can be transmitted using PUSCH transmission satisfying the second timeline.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

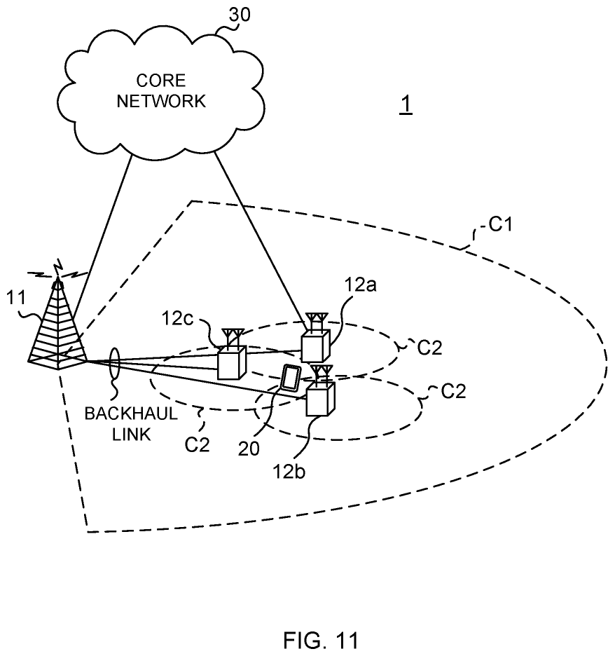

FIG. 11 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

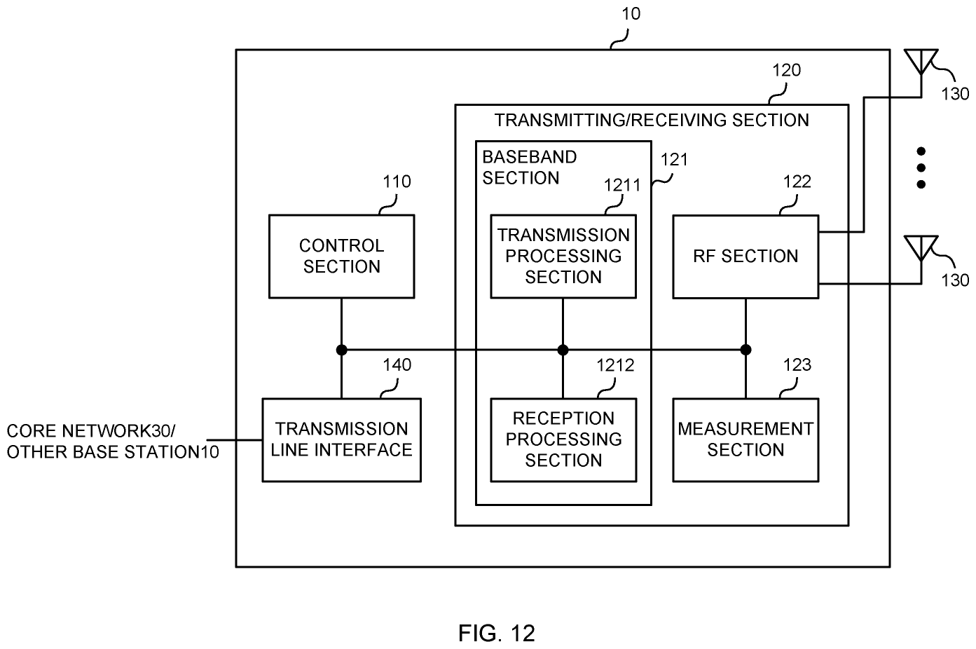

FIG. 12 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit information related to a priority of at least one of a UL channel and channel state information.

The control section 110 may, when a plurality of UL channels repeatedly transmitted one or more times in a slot and channel state information using an uplink control channel overlap in a time domain, and priorities of the UL channels and the channel state information are same, perform control of reception of the channel state information to be mapped to a specific UL channel out of the plurality of UL channels.

### (User Terminal)

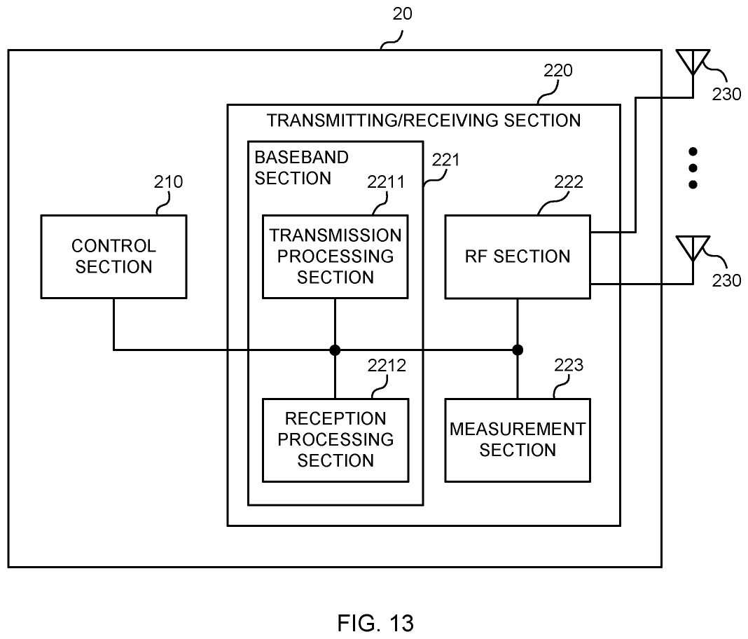

FIG. 13 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may transmit at least one of a UL channel (PUSCH) and channel state information.

The control section 210 may, when a plurality of UL channels repeatedly transmitted one or more times in a slot and channel state information using an uplink control channel overlap in a time domain, and priorities of the UL channels and the channel state information are same, perform control to map the channel state information to a specific UL channel out of the plurality of UL channels.

The specific UL channel may at least include a UL channel overlapping the uplink control channel in the time domain. The specific UL channel may at least include a UL channel not overlapping the uplink control channel in the time domain.

The control section 210 may determine the specific UL channel, based on at least one of a symbol length, a size, and number of resource elements of each UL channel.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

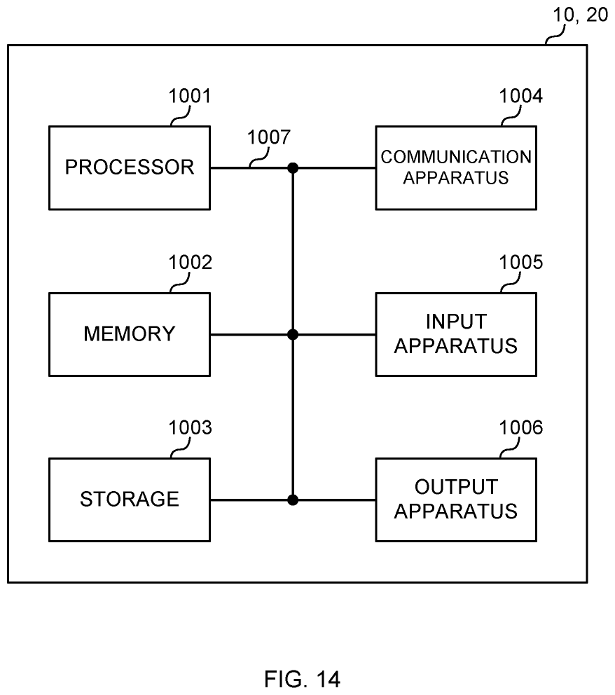

For example, a base station, a user terminal, and so on according to one embodiment of the present disclosure may function as a computer that executes the processes of the radio communication method of the present disclosure. FIG. 14 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a mobbing object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that, when a plurality of UL channels repeatedly transmitted one or more times in a slot and channel state information using an uplink control channel overlap in a time domain, and priorities of the plurality of UL channels and the channel state information are same, performs control to map the channel state information to a specific UL channel out of the plurality of UL channels; and
a transmitting section that transmits at least one of the plurality of UL channels and the channel state information.

2. The terminal according to claim 1, wherein the specific UL channel at least includes a UL channel overlapping the uplink control channel in the time domain.

3. The terminal according to claim 1, wherein the specific UL channel at least includes a UL channel not overlapping the uplink control channel in the time domain.

4. The terminal according to claim 1, wherein the control section determines the specific UL channel, based on at least one of a symbol length, a size, and number of resource elements of each of the plurality of UL channels.

5. A radio communication method for a terminal, the radio communication method comprising:
when a plurality of UL channels repeatedly transmitted one or more times in a slot and channel state information using an uplink control channel overlap in a time domain, and priorities of the plurality of UL channels and the channel state information are same, performing control to map the channel state information to a specific UL channel out of the plurality of UL channels; and
transmitting at least one of the plurality of UL channels and the channel state information.

6. A base station comprising:
a transmitting section that transmits information related to a priority of at least one of a UL channel and channel state information; and
a control section that, when a plurality of UL channels repeatedly transmitted one or more times in a slot and channel state information using an uplink control channel overlap in a time domain, and priorities of the plurality of UL channels and the channel state information are same, performs control of reception of the channel state information to be mapped to a specific UL channel out of the plurality of UL channels.

7. The terminal according to claim 2, wherein the specific UL channel at least includes a UL channel not overlapping the uplink control channel in the time domain.
